(19) United States
(12) Patent Application Publication
(10) Pub. No.: US 2012/0025524 A1
(43) Pub. Date: Feb. 2, 2012

(54) GRIP RING ASSEMBLY

(76) Inventors: Eliezer Krausz, Tel Aviv (IL); Avi Chiproot, K far-Saba (IL)

(21) Appl. No.: 12/846,847

(22) Filed: Jul. 30, 2010

(51) Int. Cl. F16L 19/06

(52) U.S. Cl. 285/421; 285/420

(57) ABSTRACT

A grip ring assembly including at least one yoke assembly for assembling on to a pipe that is to be coupled axially to a mechanical part, the at least one yoke assembly including an upper yoke and a lower yoke, wherein the at least one yoke assembly includes at least one axial fastener receiving member and the upper and lower yokes includes at least one transverse fastener receiving member generally transverse to the at least one axial fastener receiving member, a plurality of grip elements tightenable against outer surfaces of the pipes, radially spaced from one another and disposed along annular inner surfaces of the upper and lower yokes, at least one first transverse fastener operative to fasten the transverse fastener receiving members of the upper and lower yokes of the at least one yoke assembly to one another, and at least one axial fastener operative to fasten the at least one axial fastener receiving member to the mechanical part.

### FIELD OF THE INVENTION

The present invention relates generally to grip rings for pipes, and particularly to a grip ring assembly with axial fasteners that prevent axial separation of the pipes being coupled.

### BACKGROUND OF THE INVENTION

Many kinds of removable band-type couplings for pipes exist in the art. It is noted that throughout the specification and claims, the term “pipe” encompasses any kind of generally cylindrical object.

For example, one commercially available type of pipe coupling is in the form of a grip ring. There is a plurality of wedge-shaped grip elements radially spaced from one another to form a ring. The grip elements are formed with teeth that face inwards towards the center of the ring. A clamp is provided, which when tightened in a direction transverse to the axial length of the pipe, press the grip ring against the surface of the pipe.

However, there are applications which require significant force to prevent axial separation of the pipes being coupled.

### SUMMARY OF THE INVENTION

The present invention seeks to provide an improved grip ring assembly with axial fasteners that prevent axial separation of the pipes being coupled, as is described more in detail hereinbelow. The grip ring of the present invention can be advantageously assembled and tightened on to a wide variety of diameters and materials of pipes (e.g., metal and plastic).

There is thus provided in accordance with an embodiment of the present invention grip ring assembly including at least one yoke assembly for assembling on to a pipe that is to be coupled axially to a mechanical pail, the at least one yoke assembly including an upper yoke and a lower yoke, wherein the at least one yoke assembly includes at least one axial fastener receiving member and the upper and lower yokes includes at least one transverse fastener receiving member generally transverse to the at least one axial fastener receiving member, a plurality of grip elements tightenable against outer surfaces of the pipes, radially spaced from one another and disposed along annular inner surfaces of the upper and lower yokes, at least one first transverse fastener operative to fasten the transverse fastener receiving members of the upper and lower yokes of the at least one yoke assembly to one another, and at least one axial fastener operative to fasten the at least one axial fastener receiving member to the mechanical part.

In accordance with an embodiment of the present invention the grip elements are wedge shaped and include gripping teeth projecting towards an outer surface of the pipes.

In accordance with an embodiment of the present invention a plurality of individual flexible elements are affixed to side portions of adjacent grip elements.

In accordance with an embodiment of the present invention annular inner surfaces of the upper and lower yokes include adjoining abutment surfaces that form an acute angle, and the grip elements have a wedge shape that is received in and abuts against the adjoining abutment surfaces.

In accordance with an embodiment of the present invention a seal presses against at least one of the pipes. The seal may be axially distanced from the at least one yoke assembly.

### BRIEF DESCRIPTION OF THE DRAWINGS

The present invention will be understood and appreciated more fully from the following detailed description, taken in conjunction with the drawing in which:

FIGS. 1A and 1B are simplified pictorial and exploded illustrations, respectively, of a multi-purpose grip ring assembly, constructed and operative in accordance with an embodiment of the present invention; and

FIG. 2 is a simplified sectional illustration of the grip ring assembly of FIGS. 1A-1B.

### DETAILED DESCRIPTION OF EMBODIMENTS

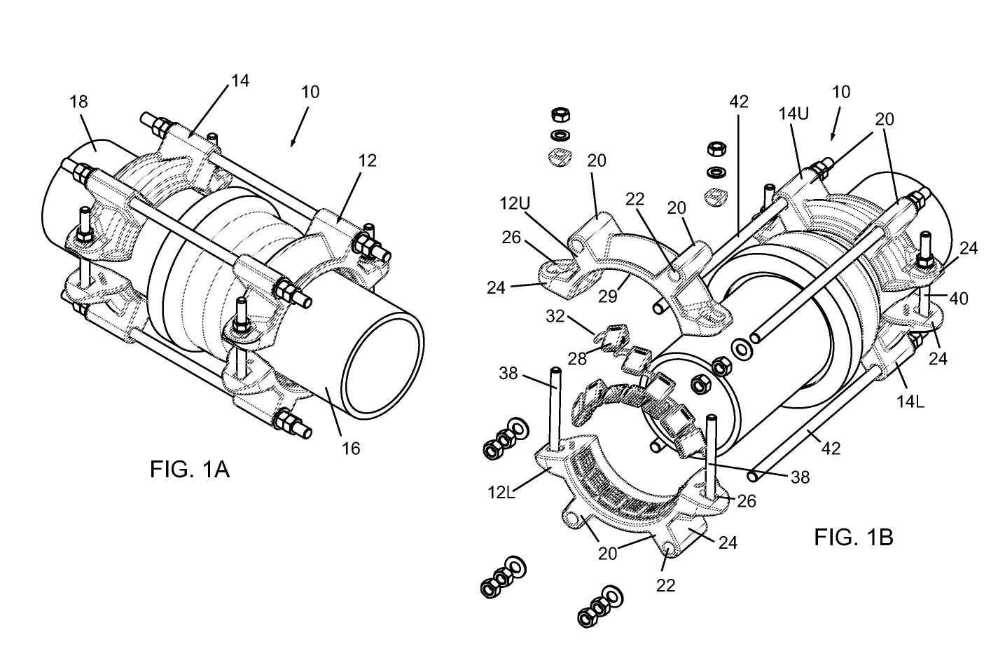

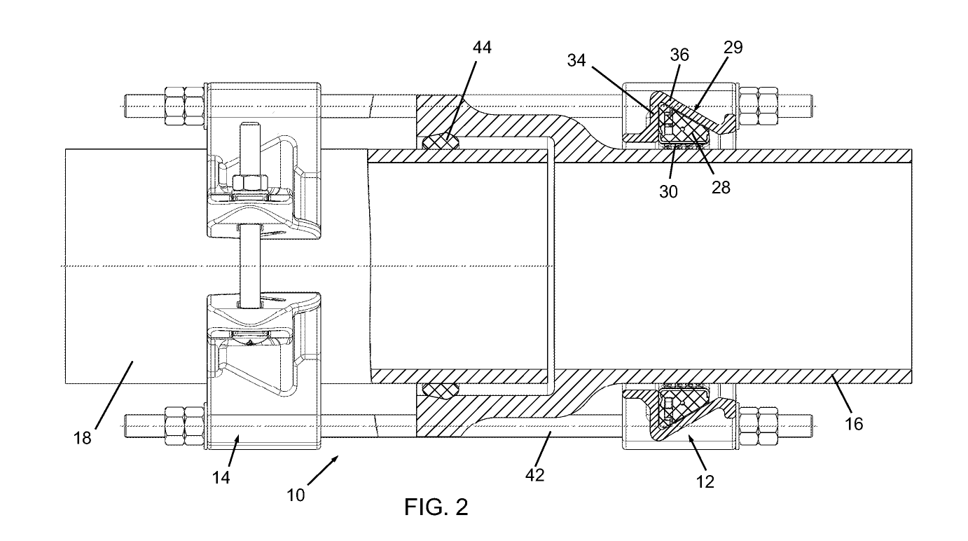

Reference is now made to FIGS. 1A, 1B and 2, which illustrate a grip ring assembly 10, constructed and operative in accordance with a non-limiting embodiment of the present invention.

Grip ring assembly 10 includes at least one yoke assembly. In the illustrated embodiment, there are two such yoke assemblies—first and second yoke assemblies 12 and 14 axially spaced apart for assembling on to pipes 16 and 18 that are to be coupled axially to one another. Alternatively, there may be just one yoke assembly which is assembled on one pipe and connected to a flange or other mechanical part. Each yoke assembly 12 and 14 includes at least two yokes, referred herein as an upper yoke 12U/14U and a lower yoke 12L/14L. It is to he understood that, particularly for large diameter pipes, there may be three, four, five or more yokes. so the terms “upper” and “lower” are not limited to being actually upper or lower in the sense of up and down.

Each of the yoke assemblies includes one or more axial fastener receiving members 20, which may be fashioned as lugs with mounting holes 22, the lugs protruding out from the yoke at an angle. In the illustrated embodiment there are two such axial fastener receiving members 20 for each upper yoke and each lower yoke.

Each of the upper and lower yokes includes one or more transverse fastener receiving members 24, which may be fashioned as lugs with mounting holes 26 generally transverse to the axial fastener receiving members 20. In the illustrated embodiment there are two such transverse fastener receiving members 24 for each upper yoke and each lower yoke. Alternatively, there could be just one for each yoke, and instead of the second receiving member 24, the upper and lower yokes may be hinged together, for example.

A plurality of grip elements 28, tightenable against the outer surfaces of the pipes, are radially spaced from one another and disposed along annular inner surfaces 29 of the upper and lower yokes. The grip elements may be wedge shaped and may include gripping teeth 30 projecting towards the outer surface of the pipes. In accordance with an embodiment of the present invention a plurality of individual flexible elements 32 (which may be springs or rods, for example) are affixed to side portions of adjacent grip elements 28, such as in holes formed in the sides of grip elements 28. Grip elements 28 are tightenable against different diameters and different materials of pipes.

In accordance with an embodiment of the present invention, as seen in FIG. 2, the annular inner surfaces 29 of the upper and lower yokes include adjoining abutment surfaces 34 and 36 that form an acute angle. The grip elements 28 have a wedge shape that is received in and abuts against the adjoining abutment surfaces 34 and 36.

One or more first transverse fasteners 38 fastens the transverse fastener receiving members 24 of the upper and lower yokes 12U and 12L of the first yoke assembly 12 to one another. Similarly, one or more second transverse fasteners 40 fasten the transverse fastener receiving members 24 of the upper and lower yokes 14U and 14L of the second yoke assembly 14 to one another. One or more axial fasteners 42 fasten the axial fastener receiving members 20 of the first and second yoke assemblies 12 and 14 to one another. Each of these fasteners may include threaded fasteners (e.g., bolts, nuts and washers) as shown in the drawings. As mentioned before. in an alternative embodiment. there may he just one yoke assembly which is assembled on one pipe and connected to a flange or other mechanical part, in which case axial fasteners 42 fasten the axial fastener receiving members 20 of the single yoke assembly to that flange or mechanical part. Thus, in general, the axial fasteners 42 fasten the axial fastener receiving members 20 of one yoke assembly to some mechanical part, that part being a flange, another pipe, etc.

In accordance with an embodiment of the present invention a seal 44 presses against at least one of the pipes. Seal 44 may be axially distanced from both of the first and second yoke assemblies 12 and 14.

The scope of the present invention includes both combinations and subcombinations of the features described hereinabove as well as modifications and variations thereof which would occur to a person of skill in the art upon reading the foregoing description and which are not in the prior art.

What is claimed is:

1. A grip ring assembly comprising:
at least one yoke assembly for assembling on to a pipe that is to be coupled axially to a mechanical part, said at least one yoke assembly comprising an upper yoke and a lower yoke, wherein said at least one yoke assembly comprises at least one axial fastener receiving member and said upper and lower yokes comprises at least one transverse fastener receiving member generally transverse to said at least one axial fastener receiving member;
a plurality of grip elements tightenable against an outer surface of the pipe, radially spaced from one another and disposed along annular inner surfaces of said upper and lower yokes;
at least one first transverse fastener operative to fasten said transverse fastener receiving members of said upper and lower yokes of said at least one yoke assembly to one another; and
at least one axial fastener operative to fasten said at least one axial fastener receiving member to said mechanical part.

2. The grip ring assembly according to claim 1, wherein said grip elements are wedge shaped and comprise gripping teeth projecting towards an outer surface of the pipes.

3. The grip ring assembly according to claim 1, wherein a plurality of individual flexible elements are affixed to side portions of adjacent grip elements.

4. The grip ring assembly according to claim 1, wherein annular inner surfaces of said upper and lower yokes comprise adjoining abutment surfaces that form an acute angle, and wherein said grip elements have a wedge shape that is received in and abuts against said adjoining abutment surfaces.

5. The grip ring assembly according to claim 1, further comprising a seal operative to press against the pipe.

6. The grip ring assembly according to claim 5, wherein said seal is axially distanced from said at least one yoke assembly.

7. The grip ring assembly according to claim 1, wherein said grip elements are tightenable against different diameters of pipes.

8. The grip ring assembly according to claim 1, wherein said grip elements are tightenable against different materials of pipes.

9. The grip ring assembly according to claim 1, wherein said at least one axial fastener comprises a threaded fastener.

10. The grip ring assembly according to claim 1, wherein said at least one first transverse fastener comprises a threaded fastener.

11. The grip ring assembly according to claim 1, wherein said at least one second transverse fastener comprises a threaded fastener.
